(19) United States
(12) Patent Application Publication
(10) Pub. No.: US 2020/0133972 A1
(43) Pub. Date: Apr. 30, 2020

(54) DISPLAY METHOD AND DISPLAY APPARATUS

(71) Applicant: SEIKO EPSON CORPORATION, Tokyo (JP)

(72) Inventor: Yusuke YAMADA, Shiojiri-shi (JP)

(73) Assignee: SEIKO EPSON CORPORATION, Tokyo (JP)

(21) Appl. No.: 16/666,510

(22) Filed: Oct. 29, 2019

(30) Foreign Application Priority Data
Oct. 30, 2018 (JP) 2018-203695

(51) Int. Cl. G06F 16/438; G06F 16/432; G06F 16/54; G06T 3/60; G06F 3/0483

(52) U.S. Cl. CPC G06F 16/438; G06F 16/434; G06F 3/0483; G06T 3/60; G06F 16/54

(57) ABSTRACT

A display method for displaying a file image on a display section, the file image containing thumbnail images to be so displayed as to be disposed along a first imaginary axis, rotated around second imaginary axes that intersect the first imaginary axis, and further rotated around the first imaginary axis, the method including generating, when the file image has revisions, preview images corresponding to the file image for each of the revisions, and displaying the plurality of generated preview images in such a way that the preview images partially overlap with each other.

The present application is based on, and claims priority from JP Application Serial Number 2018-203695, filed Oct. 30, 2018, the disclosure of which is hereby incorporated by reference herein in its entirety.

### BACKGROUND

### 1. Technical Field

The present disclosure relates to a display method and a display apparatus.

### 2. Related Art

There has been a disclosed display method for displaying history information relating to a plurality of images contained in a plurality of folders and files on a display section. As the method for displaying the history information, for example, JP-A-2015-207043 discloses an approach for displaying a list in which letter information on history information relating to a log-in process, a print process, a folder readout process, or any other process is chronologically listed.

The display method described in JP-A-2015-207043 shows history information (hereinafter referred to as revision) in the form of a list in which the history information is shown as letter information and has, however, a problem of a difficulty in recognizing the progress or transition of revision, for example, in a folder or a file having the revision of in an image contained therein because the history image are not visually recognizable in the form of a list a display image on a revision basis.

### SUMMARY

A display method according to an aspect of the present disclosure is a display method for displaying a file image on a display section, the file image containing images to be so displayed as to be disposed along a first imaginary axis, rotated around second imaginary axes that intersect the first imaginary axis, and further rotated around the first imaginary axis, the method including generating, when the file image has revisions, preview images corresponding to the file image for each of the revisions and displaying the plurality of generated preview images in such a way that the plurality of generated preview images partially overlap with each other.

In the display method described above, the preview images may be generated in correspondence with an image selected from the plurality of images.

In the display method described above, the file image may include an image bundle in which the plurality of images are juxtaposed in a first direction and the preview images juxtaposed with the image bundle.

In the display method described above, the image bundle and the preview images may be generated for each of the revisions, and the image bundles and the preview images may be juxtaposed and displayed along a second direction that intersects the first direction.

In the display method described above, identification marks that identify the revisions of the preview images may be displayed in the preview images.

In the display method described above, when an instruction of movement of one of the preview images so displayed as to overlap with each other on a revision basis is issued, the instructed preview image may be so moved that the preview image displayed as a main-display image is switched to another.

A display method according to another aspect of the present disclosure is a display method for displaying a file image on a display section, the file image containing images to be so displayed as to be disposed along a first imaginary axis, rotated around second imaginary axes that intersect the first imaginary axis, and further rotated around the first imaginary axis. The file image contains an image bundle in which the plurality of images are juxtaposed in a first direction, and when the file image has revisions, a plurality of revision images corresponding to an image having the revisions out of the images that form the image bundle are generated, and the revision images are so displayed as to partially overlap with each other.

In the display method described above, in addition to the image having the revisions, second revision images corresponding to all the images that form the image bundle may be generated on a revision basis, and the second revision images generated on a revision basis may be so displayed as to partially overlap with each other.

In the display method described above, when an instruction of movement of one of the revision images so displayed as to overlap with each other on a revision basis is issued, the instructed revision image may be so moved that the revision image displayed as a main-display image is switched to another.

A display apparatus according to another aspect of the present disclosure includes a display section that displays a file image containing images, a thumbnail image generator that generates a plurality of the images to be so displayed as to be disposed along a first imaginary axis, rotated around a second imaginary axis that intersect the first imaginary axis, and further rotated around the first imaginary axis, and a display image generator that generates, when the file image has revisions, a preview image selected from the plurality of images on a revision basis and generates a display image in which the plurality of preview images are displayed with part thereof overlapping with each other.

A display apparatus according to another aspect of the present disclosure includes a display section that displays a file image containing images, a thumbnail image generator that generates a plurality of the images to be so displayed as to be disposed along a first imaginary axis, rotated around a second imaginary axis that intersect the first imaginary axis, and further rotated around the first imaginary axis, and a display image generator that generates, when the file image has revisions, a plurality of revision images corresponding to an image having the revisions out of the plurality of images and generates a display image in which the plurality of revision images are displayed with part thereof overlapping with each other.

### BRIEF DESCRIPTION OF THE DRAWINGS

FIG. 1 is an exterior perspective view showing an overview of a smartphone as an example of a display apparatus according to an embodiment.

FIG. 2 is a block diagram showing the hardware configuration of the display apparatus.

FIG. 3 shows Display Example 1 of a display image using preview images.

FIG. 4 is a flowchart for describing Display Method 1 using the preview images.

FIG. 5A describes the process of deforming a thumbnail image.

FIG. 5B describes the process of deforming a thumbnail image.

FIG. 5C describes the process of deforming a thumbnail image.

FIG. 5D describes the process of deforming a thumbnail image.

FIG. 5E describes the process of deforming a thumbnail image.

FIG. 6A shows the state before a preview image is moved.

FIG. 6B shows the state after a preview image is moved.

FIG. 7 is a flowchart for describing Display Method 2 using preview images.

FIG. 8 shows Display Example 2 of a display image using preview images.

FIG. 9 shows Display Example 3 of a display image using revision images.

FIG. 10 is a flowchart for describing Display Method 3 using revision images.

FIG. 11 is a diagram illustrating movement of a revision image.

FIG. 12 is a flowchart for describing Display Method 4 using revision images.

FIG. 13 shows Display Example 4 of a display image using revision images.

FIG. 14 shows Display Example 5 of a display image using revision images.

### DESCRIPTION OF EXEMPLARY EMBODIMENTS

An embodiment of a display apparatus and a method for displaying information on the display apparatus will be described below with reference to the drawings. It is not intended that the embodiment described below unduly limits the content of the present disclosure set forth in the appended claims. Further, all configurations described in the following embodiment are not necessarily essential configuration requirements of the present disclosure.

### 1. Display Apparatus

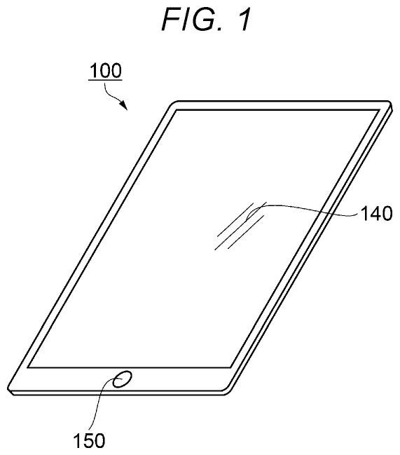

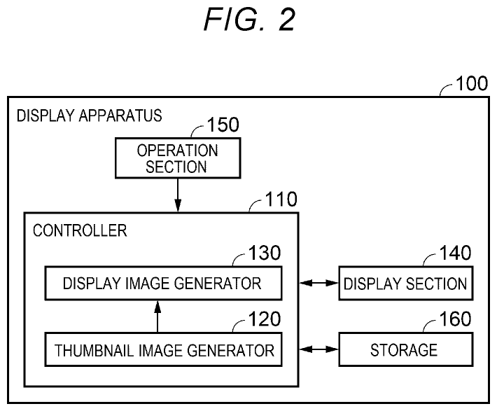

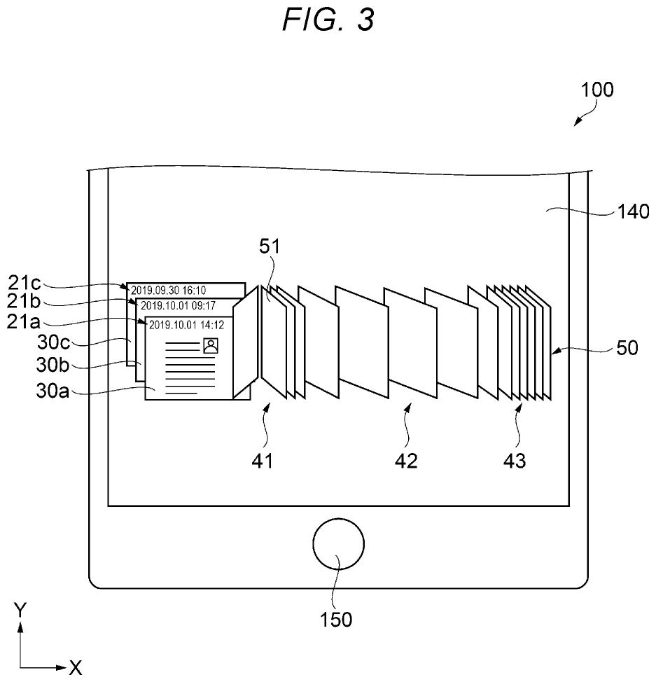

The configuration of the display apparatus according to the embodiment will first be described with reference to FIGS. 1, 2, and 3. FIG. 1 is an exterior perspective view showing an overview of a smartphone as an example of the display apparatus according to the embodiment. FIG. 2 is a block diagram showing the hardware configuration of the display apparatus. FIG. 3 shows Display Example 1 of a display image using preview images.

A display apparatus 100 is an apparatus for viewing an electronic book, electronic photographs, and the like as shown in FIG. 1 and displays, as a search screen that allows a user to search for images of the pages of a folder, a file, an electronic book, electronic photographs, and the like or a screen that the user desires to display, thumbnail images in the form of reduced images of the pages of the electronic book and the electronic photographs. That is, the display apparatus 100 is an example of an electronic instrument capable of displaying an image. In the following description, as file images displayed on a display section 140 of the display apparatus 100, a plurality of thumbnail images 51 (see FIG. 3) and a thumbnail bundle 50 (see FIG. 3) as an image bundle in which the thumbnail images 51 are juxtaposed and displayed are presented as a primary example. Further, in the present embodiment, a folder and a file are collectively called a “file” in the description.

A “first direction” and a “second direction” are used in the following description. The “first direction” in the present specification corresponds to the horizontal direction (lateral direction) in the state in which a screen that forms a display section 140 directly faces the user with a content displayed on the display section 140 readable and understandable by the user. The “second direction” is a direction that intersects the first direction and corresponds to the vertical direction (longitudinal direction) in the state in which the screen that forms the display section 140 directly faces the user with the content displayed on the display section 140 readable and understandable by the user. In each drawing used to describe the display apparatus 100 and the display section 140, two axes perpendicular to each other are set as axes X and Y for convenience of the description. That is, the axis X coincides with the “first direction,” which is the direction along the horizontal direction (lateral direction) of the display section 140, and the axis Y coincides with the “second direction,” which is the direction along the vertical direction (longitudinal direction) of the display section 140. Further, the positive side of the axis-Y direction is called “above” or an “upper side,” the negative side of the axis-Y direction is called “below” or a “lower side,” the positive side of the axis-X direction is called “right” or a “right side,” and the negative side of the axis-X direction is called “left” or a “left side.”

The display apparatus 100 can be formed, for example, of a smartphone or a tablet-shaped terminal apparatus. The display apparatus 100 can be connected to another information processing apparatus (not shown), for example, via short-distance wireless communication or wired communication (not shown) exemplified, for example, by Bluetooth (registered trademark).

The display apparatus 100 according to the present embodiment is, for example, a smartphone including the display section 140, which displays an image, and an operation section 150, such as an operation button, operated by the user, as shown in FIG. 1. The user can visually recognize an image displayed on the display section 140, which is formed, for example, of a liquid crystal display, of the display apparatus 100.

The display apparatus 100 includes as the hardware configuration a controller 110, which includes a thumbnail image generator 120 and a display image generator 130, the display section 140, the operation section 150, and a storage 160, as shown in FIG. 2.

The controller 110 includes the thumbnail image generator 120 and the display image generator 130. The controller 110 is a microcomputer including a CPU (central processing unit), a ROM (read only memory), a RAM (random access memory), and other components and controls each portion of the display apparatus 100 in accordance with a program memorized in the ROM. The controller 110 identifies the content of operation based on a signal sent from the operation section 150 and carries out the process of turning a page of an electronic book forward, the process of turning the page backward, and the process of causing the display section 140 to display a display image, such as thumbnail images and a thumbnail bundle in accordance with the identified content.

Specifically, the controller 110 can access the storage 160 and write and read a variety of data, such as an electronic book and electronic photographs, to and from the storage 160. The controller 110 can cause the thumbnail image generator 120 and the display image generator 130 to generate a variety of data relating to the pages of an electronic book, electronic photographs, and the like, thumbnail images that are reduced images of the variety of data on the electronic book, electronic photographs, and the like, and a thumbnail bundle image and generate display image data on the generated images.

The controller 110 displays an image of the thumbnail bundle 50 as the image bundle generated by the display image generator 130 on the display section 140, as shown, for example, in FIG. 3. The thumbnail bundle 50 is an image bundle in which the plurality of thumbnail images 51 as the images described above are juxtaposed and displayed in the first direction and includes a region 41, in which thumbnail images are juxtaposed in the form of images facing each other, a region 42, in which adjacent thumbnail images are juxtaposed at increased intervals, a region 43, in which thumbnail images are juxtaposed at equal intervals. In the present embodiment, the thumbnail images 51 are so shown in the thumbnail bundle 50 as to be representative of thumbnail images corresponding to a plurality of pages contained in one file.

The controller 110 displays a selected page selected from the plurality of thumbnail images 51, which form the file images and contained in the thumbnail bundle 50, or a representative page in the file as the preview image, for example, in a position on the left of the thumbnail bundle 50 in FIG. 3 in the first direction (axis-X direction in FIG. 3), which is the horizontal direction of the display section 140, in such a way that the selected or representative page is juxtaposed with the thumbnail bundle 50. In a case where any of the file images has revisions, the controller 110 generates preview images corresponding to the revisions of the file image. In other words, the controller 110 generates preview images corresponding to a file image having revisions on a revision basis.

Display Example 1 shown in FIG. 3 shows a case where a file image has three revisions by way of example, and a first preview image 30a, a second preview image 30b, and a third preview image 30c are displayed as three preview images corresponding to the revisions. Specifically, the first preview image 30a is displayed as a main-display image in a top plane nearest to the viewer. The second preview image 30b is so disposed behind the first preview image 30a as to partially overlap with the first preview image 30a. The third preview image 30c is so disposed behind the second preview image 30b as to partially overlap with the second preview image 30b. That is, the three preview images, the first preview image 30a, the second preview image 30b, and the third preview image 30c, which are so displayed as to overlap with each other, are so displayed as to be juxtaposed with one thumbnail bundle 50 in positions along the first direction (axis-X direction) of the thumbnail bundle 50.

As described above, file images displayed on the display section 140 include the thumbnail bundle 50, in which the plurality of thumbnail images 51 are juxtaposed in the first direction, and the first preview image 30a, the second preview image 30b, and the third preview image 30c as the preview images juxtaposed with the thumbnail bundle 50. The thus configured display form allows the user to readily read and understand the contents of the file images.

The controller 110 may display identification marks 21a, 21b, and 21c in the first preview image 30a, the second preview image 30b, and the third preview image 30c with, respectively, and the identification marks 21a, 21b, and 21c identify the revisions thereof. The identification marks 21a, 21b, and 21c in the present example each show the time and date when the revision was made. As described above, displaying the identification marks 21a, 21b, and 21c, which each identify the revision of the corresponding preview image, as supplementary information in the first preview image 30a, the second preview image 30b, and the third preview image 30c allows the user to readily grasp the contents of the revisions of the first preview image 30a, the second preview image 30b, and the third preview image 30c, the time and date when the revisions were made, and other pieces of information.

In Display Example 1, the display section 140 displays one thumbnail bundle 50, but the number of thumbnail bundles is not limited to one, and the display section 140 may display a plurality of thumbnail bundles. Even when a plurality of thumbnail bundles are displayed, preview images may be displayed on a revision basis.

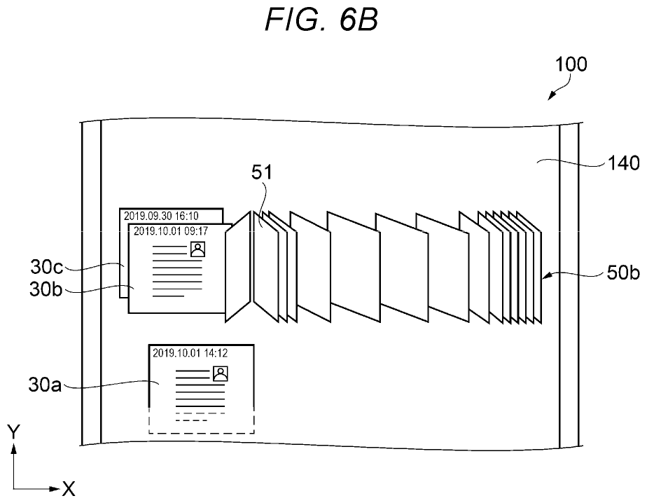

When the user touches the screen of the display section 140 and performs, for example, a drag-and-drop action, a flick action, or any other action, as indicated by the arrow S1 in Display Example 1 in FIG. 6A, the controller 110 can move the positions where the first preview image 30a, the second preview image 30b, and the third preview image 30c are displayed to change the main-display image.

The thumbnail image generator 120 reads a variety of types of data from the storage 160 and generates the thumbnail images 51, which are reduced images of the variety of types of data on an electronic book, electronic photographs, and the like.

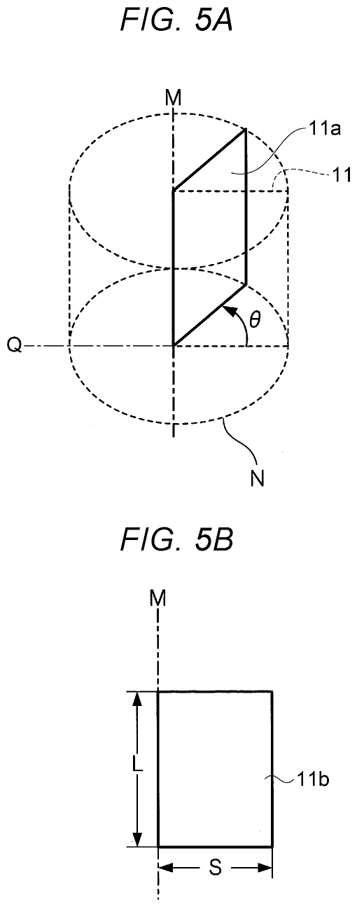

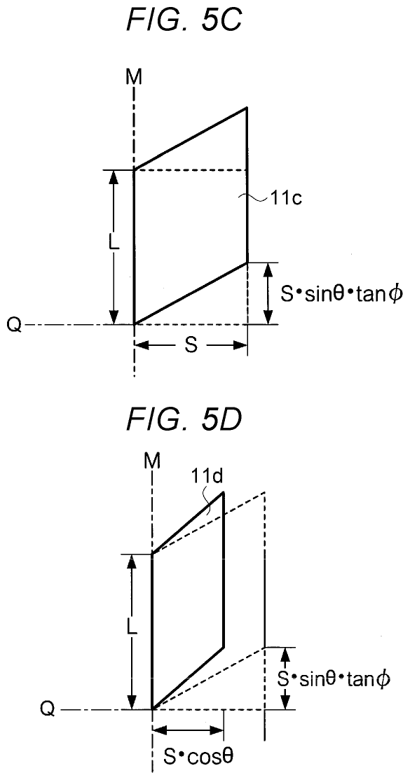

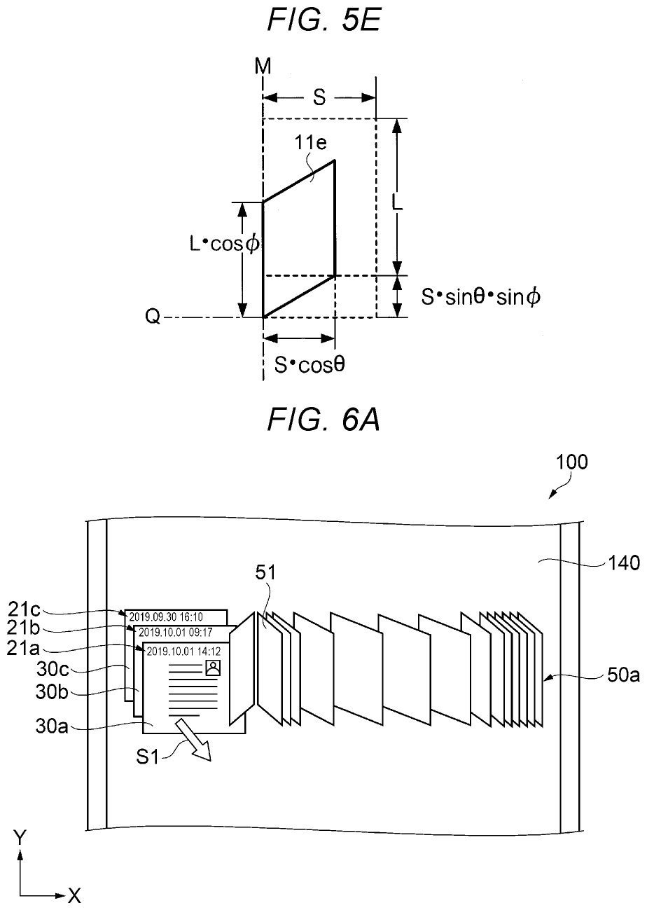

Specifically, the thumbnail image generator 120 generates the thumbnail images 51 shown in FIG. 3, for example, in the form of a plurality of images disposed along a first imaginary axis extending in the first direction, which is the horizontal direction of the screen that forms the display section 140, rotated around respective second imaginary axes that intersect the first imaginary axis and extend along the second direction, which is the vertical direction of the screen of the display section 140, and further rotated around the first imaginary axis. A method for generating the plurality of thumbnail images 51 will be described later in detail with reference to FIGS. 5A to 5E.

The display image generator 130 generates an image of the thumbnail bundle 50, in which the thumbnail images 51 representing a plurality of pages and generated by the thumbnail image generator 120 are juxtaposed along the first direction (axis-X direction), which is the horizontal direction of the display section 140, as shown in FIG. 3. That is, the display image generator 130 configures one thumbnail bundle, for example, the thumbnail bundle 50 in such a way that the thumbnail bundle 50 contains the thumbnail images 51 of the pages contained in one file and viewed in a bird's eye view. The display image generator 130 further generates a preview image that is an image of a page selected and opened by the user or an image of a representative page, for example, the first preview image 30a, the second preview image 30b, and the third preview image 30c and generates file images in combination with the thumbnail bundle 50. The number of thumbnail bundles 50 disposed on the display section 140 is not limited to one and may be plural.

In the case where file images each contain revisions, the display image generator 130 can generate a plurality of revision images 52b, 53b, 54b, 52c, 53c, and 54c corresponding to thumbnail images 52a, 53a, and 54a each having revisions out of thumbnail images 52a, 53a, 54a, and 55a as the plurality of images and generate a display image in which the plurality of revision images 52b, 53b, 54b, 52c, 53c, and 54c are displayed with part thereof overlapping with each other. That is, the display image generator 130 can dispose the revision images 52b and 52c in such a way that the revision images 52b and 52c partially overlap with the thumbnail image 52a, dispose the revision images 53b and 53c in such a way that the revision images 53b and 53c partially overlap with the thumbnail image 53a, dispose the revision images 54b and 54c in such a way that the revision images 54b and 54c partially overlap with the thumbnail image 54a, and display the entire images on the display section 140.

Referring back to FIGS. 2 and 3, the display section 140 displays, for example, the thumbnail bundle 50, which contains the plurality of thumbnail images 51, and the first preview image 30a, the second preview image 30b, and the third preview image 30c as the preview images of a selected page selected from the plurality of thumbnail images 51 contained in the thumbnail bundle 50 or a page selected as a representative page of the file based on an instruction from the controller 110. The display section 140 can be formed, for example of a touch panel that is the combination of a liquid crystal display and a position input apparatus, such as a touch pad.

The operation section 150 is formed, for example, of an operation button or a touch panel operated by the user. The operation section 150 can send the controller 110 an operation signal produced by the user's operation of pressing the operation button, performing a drag-and-drop action or a flick action on the touch panel, or any other operation.

The storage 160 is a memory that memorizes electronic book data, electronic photograph data, and other types of data as image data to be displayed on the display section 140. The storage 160 can memorize as a file, for example, a file that stores a plurality of pages relating to data on a plurality of electronic book as one unit and a file that stores data on a plurality of electronic photographs as one unit.

The display apparatus 100 according to the present embodiment performs the display action by using the thumbnail images 51, which are generated by the thumbnail image generator 120, as a plurality of images that are images of pages displayed in a bird's eye view in an imaginary space disposed along the first imaginary axis along the first direction (axis X), which is the horizontal direction of the screen that forms the display section 140, rotated around the second imaginary axis that intersects the first imaginary axis and extends along the second direction (axis Y), and further rotated around the first imaginary axis. The display apparatus 100 displays, as file images generated by the display image generator 130, the thumbnail bundle 50 as an image bundle in which the plurality of thumbnail images 51 are juxtaposed and disposed in the first direction and the first preview image 30a, the second preview image 30b, and the third preview image 30c selected from the plurality of thumbnail images 51 contained in the thumbnail bundle 50 and so disposed as to be partially overlapping with each other on the display section 140. The first preview image 30a, the second preview image 30b, and the third preview image 30c are generated in relation to revisions of a file image and are displayed on the display section 140. The display apparatus 100 that performs the display operation described above allows the user to readily visually recognize the first preview image 30a, the second preview image 30b, and the third preview image 30c generated on a revision basis and displayed on the display section 140 as a display image in the form of a list.

The controller 110 may display thumbnail images corresponding to the preview images in the form of images facing each other. The thumbnail images corresponding to the preview images are arranged in the thumbnail bundle 50, other thumbnail images in the vicinity of the thumbnail images displayed in the form of images facing each other are displayed with a widened gap therebetween. The thus displayed other thumbnail images located in the vicinity of the thumbnail images corresponding to the preview images in the thumbnail bundle 50 can be readily viewed, whereby the display apparatus 100 allows the user to readily grasp the contents of the other thumbnail images.

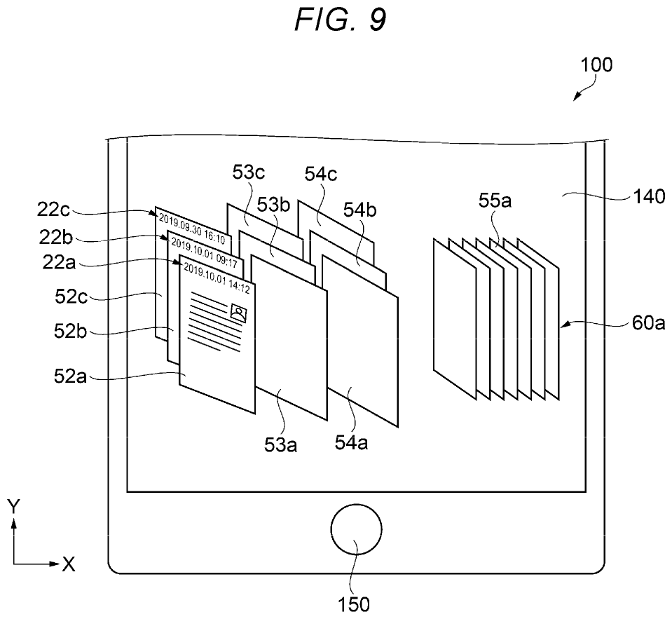

Further, when a file image has revisions, the display apparatus 100 according to the present embodiment can generate the plurality of revision images 52b, 53b, 54b, 52c, 53c, and 54c corresponding to the thumbnail images 52a, 53a, and 54a each having revisions out of the thumbnail images 52a, 53a, 54a, and 55a as the plurality of images generated by the thumbnail image generator 120 and generate a display image in which the plurality of revision images 52b, 53b, 54b, 52c, 53c, and 54c are so displayed as to partially overlap with each other, as described with reference to FIG. 9. The display apparatus 100 that performs the display operation described above allows the user to readily visually recognize the plurality of revision images 52b, 53b, 54b, 52c, 53c, and 54c generated on a revision basis and displayed on the display section 140 as a display image in the form of a list.

### 2. Display Method

### 2.1. Display Method 1

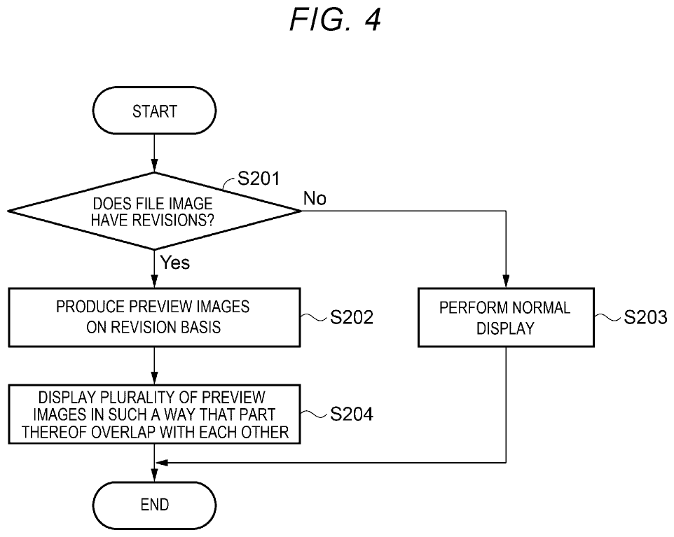

Display Method 1, to which Display Example 1 is applied in the display apparatus 100, will next be described with reference to FIG. 4. FIG. 4 is a flowchart for describing Display Method 1 using preview images and shows the procedure of processes carried out by the display apparatus 100. Display Example 1 will be described with reference to FIG. 3 described above. The description will be made with the constituent portions of the display apparatus 100 labeled with the same reference characters described above.

Before the procedure of Display Method 1, the controller 110 instructs the thumbnail image generator 120 to generate the thumbnail images 51 in a selected file, instructs the display image generator 130 to generate the thumbnail bundle 50, in which the plurality of generated thumbnail images 51 are arranged in the first direction, and displays the thumbnail bundle 50 on the display section 140. The controller 110 then generates a preview image corresponding to an image selected from the plurality of thumbnail images 51, for example, the first preview image 30a. In this process, the controller 110 may display thumbnail images corresponding to the selected preview image in the form of images facing each other. As described above, since the preview image corresponding to the image selected from the plurality of thumbnail images 51, which form the file images, for example, the first preview image 30a is displayed, the user can visually recognize the first preview image 30a to readily grasp the content of the file images.

The thumbnail images 51 as the plurality of images are, for example, images so displayed as to be disposed along the first imaginary axis extending along the first direction of the screen that forms the display section 140, rotated around the respective second imaginary axes, which intersect the first imaginary axis and extend along the second direction of the screen that forms the display section 140, and further rotated around the first imaginary axis. Rotating the thumbnail images 51 around the first and second imaginary axes allows the thumbnail bundle 50 formed of the plurality of thumbnail images 51 to be so deformed as to be viewed in a bird's eye view when the screen faces the user in such a way that the user can read and understand the content displayed on the screen. That is, the plurality of page-representing thumbnail images 51 contained in the thumbnail bundle 50 are so deformed as to be viewed in the same manner in which the thumbnail images 51 are viewed obliquely downward in a bird's eye view.

The process of deforming a thumbnail image will now be described with reference to FIGS. 5A, 5B, 5C, 5D, and 5E. FIGS. 5A to 5E describe the process of deforming a thumbnail image. In the following description of the process of deforming a thumbnail image, the reference character 51 attached to the thumbnail images in the above description is omitted.

Each thumbnail image supplied from the thumbnail image generator 120 is an image of a page of an electronic book, electronic photographs, or the like in the plan view and is specifically an image 11b having a longitudinal length L and a lateral length S, as shown in FIG. 5B. In other words, the image 11b has longitudinal sides parallel to the longitudinal direction along the second direction of the display section 140 and lateral sides parallel to the lateral direction along the first direction of the display section 140.

The thumbnail image generator 120 generates an image that is a deformed thumbnail image representing a page of an electronic book, electronic photographs, or the like. Specifically, the thumbnail image generator 120 disposes a page 11a that stands upward on a first imaginary axis Q, which is set in an imaginary horizontal plane N in an imaginary space, and rotates the page 11a by an angle of rotation θ from a reference position 11, where the lateral direction of the page 11a is parallel to the lateral direction of the display section 140, around a secondary imaginary axis M, which intersects the first imaginary axis Q. The thumbnail image generator 120 further generates an image that is the page 11a rotated around the second imaginary axis M and further rotated by an angle of depression (not shown) with respect to the first imaginary axis Q in the imaginary space. That is, the thumbnail image generator 120 generates an image that is the page 11a viewed obliquely downward at the angle of depression ϕ (not shown) from a viewpoint above the upper side of the page 11a rotated around the second imaginary axis M in the imaginary space. In other words, the image that is a deformed thumbnail image is generated as an image of the page 11a obliquely viewed at the angle of depression ϕ (not shown) from a viewpoint above the upper side of the page 11a in a bird's eye view in the imaginary space. In a case where the page is not rotated, the lateral direction of the page is parallel to the lateral direction of the display section 140 (first direction), and the angle of rotation θ is 0°. The angle of depression ϕ is an angle specified in advance. The second imaginary axis M is not necessarily parallel to the longitudinal sides (sides extending in second direction) of the page and may intersect the lateral sides of the page.

Specifically, the thumbnail image generator 120 first longitudinally deforms the image 11b (see FIG. 5B) of the page viewed from the front side thereof with no change in the lateral width of the image 11b and shifts the right side of the image 11b shown in FIG. 5B relative to the left side thereof by S·sin θ·tan ϕ to generate an image 11c, as shown in FIG. 5C. The thumbnail image generator 120 then reduces the image 11c shown in FIG. 5C in the lateral direction by a factor of cos θ to generate an image 11d, as shown in FIG. 5D. As a result, the lateral width of the image 11d is S·cos θ. The thumbnail image generator 120 reduces the image 11d shown in FIG. 5D in the longitudinal direction by a factor of cos ϕ to finally generate an image 11e, as shown in FIG. 5E. As a result, the longitudinal dimension of the image 11e is L·cos ϕ. The thus produced image 11e is an image of the page rotated by the angle of rotation θ around the second imaginary axis M and further rotated around the first imaginary axis Q. In other words, the thus produced image 11e is an image of the page rotated by the angle of rotation θ around the second imaginary axis M and viewed downward at the angle of depression ϕ from a viewpoint above the upper side of the page.

The angle of rotation θ is set at an angle of rotation θ1 specified in advance in the case of a selected page identified by selected page data and is set at an angle of rotation −θ1 specified in advance in the case of the page that immediately precedes the selected page. In the case of a page other than the selected page, the angle of rotation θ is gradually increased as the page number increases or decreases from that of the selected page; the angle of rotation θ by which a page after the selected page is rotated is so set as to fall within θ1<θ<90° in the present embodiment, and the angle of rotation θ by which a page before the selected page is rotated is so set as to fall within −θ1>−θ>−90° in the present embodiment.

The controller 110 then evaluates whether or not the displayed file image has revisions (step S201), as shown in the flowchart of FIG. 4. In a case where the file image has revisions (Yes in step S201), the controller 110 instructs the display image generator 130 to generate, for example, the first preview image 30a, the second preview image 30b, and the third preview image 30c as the preview images on a revision basis (step S202).

In a case where the file image has no revision (No in step S201), the controller 110 generates a preview image of a representative page or any other image and normally displays the thumbnail bundle 50 and, for example, the first preview image 30a as one preview image selected from the thumbnail images 51 and to be disposed in a position adjacent to the thumbnail bundle 50 in the first direction (step S203).

The controller 110 then instructs the display image generator 130 to generate a display image in which the first preview image 30a, the second preview image 30b, and the third preview image 30c generated on a revision basis are so disposed as to partially overlap with each other and displays the display image on the display section 140 (step S204).

In step S204, the display image generator 130 specifically disposes the first preview image 30a as a main-display image in a position nearest to the viewer, disposes the second preview image 30b behind the first preview image 30a in such a way that the second preview image 30b partially overlaps with the first preview image 30a, and disposes the third preview image 30c behind the second preview image 30b in such a way that the third preview image 30c partially overlaps with the second preview image 30b. That is, the display image generator 130 disposes the three preview images, the first preview image 30a, the second preview image 30b, and the third preview image 30c, which are so displayed as to overlap with each other, in such a way that the three preview images are juxtaposed with the single thumbnail bundle 50 in positions along the first direction (axis X) of the thumbnail bundle 50 and displays the thus disposed three preview images on the display section 140.

The controller 110 displays the identification marks 21a, 21b, and 21c, which identify the revisions of the first preview image 30a, the second preview image 30b, and the third preview image 30c, respectively, in the first preview image 30a, the second preview image 30b, and the third preview image 30c. The identification marks 21a, 21b, and 21c in the present example each show the time and date when the revision was made. As described above, displaying the identification marks 21a, 21b, and 21c, which each identify the revision of the corresponding preview image, as supplementary information in the first preview image 30a, the second preview image 30b, and the third preview image 30c allows the user to readily grasp the contents of the revisions of the first preview image 30a, the second preview image 30b, and the third preview image 30c, the time and date when the revisions were made, and other pieces of information.

The series of processes in Display Method 1 for displaying Display Example 1 on the display section 140 end after the processes are carried out in accordance with the procedure described above.

According to the thus configured Display Method 1, the first preview image 30a, the second preview image 30b, and the third preview image 30c are generated as preview images corresponding to revisions of a file image and so displayed as to partially overlap with each other. The user can therefore visually recognize the first preview image 30a, the second preview image 30b, and the third preview image 30c as the plurality of preview images generated in relation to the revisions of the file image in the form of a list of the nonoverlapping portions of the preview images, whereby the user can readily recognize the contents of the progress of the revisions and transition thereof.

Further, according to Display Method 1, in which preview images correspond to an image selected from the thumbnail images 51 as a plurality of images that form file images, the user can readily grasp the content of the file image by visually recognizing the preview images.

Moreover, according to Display Method 1, in which a file image is displayed in the display form in which preview images are juxtaposed with the thumbnail bundle 50, in which the plurality of thumbnail images 51 are juxtaposed, the user can readily read and understand the content contained in the file image.

### Display Method 2

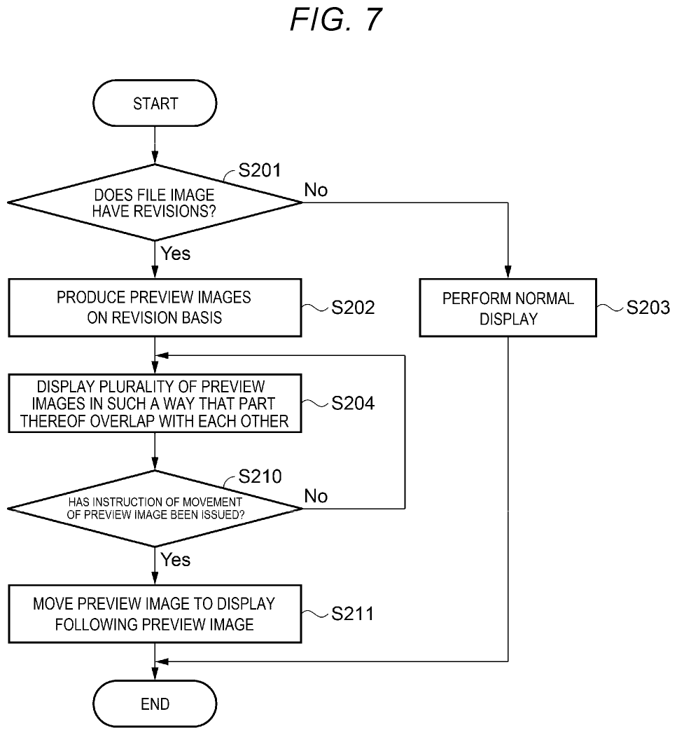

Display Method 2 used with the display apparatus 100 will next be described with reference to FIGS. 6A and 6B and FIG. 7. FIG. 6A shows the state before a preview image is moved. FIG. 6B shows the state after a preview image is moved. FIG. 7 is a flowchart for describing Display Method 2 using preview images. Display Method 2 uses the display configuration in which preview image on a revision basis are juxtaposed with the thumbnail bundle 50 formed of a plurality of thumbnail images 51, which is the same as the configuration described with reference to Display Method 1 described above. The same configurations as those in Display Method 1 therefore have the same reference characters. The description of Display Method 2 and Display Example 2 will also be made with the constituent portions of the display apparatus 100 labeled with the same reference characters described above.

Before the procedure of Display Method 2, the controller 110 first instructs the thumbnail image generator 120 to generate the thumbnail images 51 in a selected file, instructs the display image generator 130 to generate a thumbnail bundle 50a, in which the plurality of generated thumbnail images 51 are arranged in the first direction, and displays the thumbnail bundle 50a on the display section 140, as shown in FIG. 6A, as in Display Method 1. At this point, the controller 110 may display thumbnail images corresponding to selected preview images in the form of images facing each other. The thumbnail images 51 are generated in the same manner as in Display Method 1 and will therefore not be described in detail.

The controller 110 then evaluates whether or not the displayed file image has revisions (step S201), as shown in the flowchart of FIG. 7. In a case where the file image has revisions (Yes in step S201), the controller 110 instructs the display image generator 130 to generate, for example, the first preview image 30a, the second preview image 30b, and the third preview image 30c as the preview images on a revision basis (step S202).

In a case where the file image has no revision (No in step S201), the controller 110 generates a preview image of a representative page or any other image and normally displays the thumbnail bundle 50 and one preview image corresponding to a thumbnail image in the thumbnail bundle 50 and to be disposed in a position adjacent to the thumbnail bundle 50 in the first direction (step S203).

The controller 110 then instructs the display image generator 130 to generate a display image in which the first preview image 30a, the second preview image 30b, and the third preview image 30c generated on a revision basis are so disposed as to partially overlap with each other and displays the display image on the display section 140 (step S204).

In step S204, the display image generator 130 specifically disposes the first preview image 30a as a main-display image in a position nearest to the viewer, disposes the second preview image 30b behind the first preview image 30a in such a way that the second preview image 30b partially overlaps with the first preview image 30a, and disposes the third preview image 30c behind the second preview image 30b in such a way that the third preview image 30c partially overlaps with the second preview image 30b. That is, the display image generator 130 disposes the three preview images, the first preview image 30a, the second preview image 30b, and the third preview image 30c, which are so displayed as to overlap with each other, in such a way that the three preview images are juxtaposed with the single thumbnail bundle 50 in positions along the first direction (axis-X direction) of the thumbnail bundle 50 and displays the thus disposed three preview images on the display section 140.

The controller 110 displays the identification marks 21a, 21b, and 21c, which identify the revisions of the first preview image 30a, the second preview image 30b, and the third preview image 30c, respectively, in the first preview image 30a, the second preview image 30b, and the third preview image 30c. The identification marks 21a, 21b, and 21c are preferably provided in areas where they do not overlap with each other but are fully exposed when the first preview image 30a, the second preview image 30b, and the third preview image 30c overlap with each other. That is, even when the first preview image 30a, the second preview image 30b, and the third preview image 30c are so displayed as to overlap with each other, the identification marks 21a, 21b, and 21c can be fully viewed. The identification marks 21a, 21b, and 21c in the present example each show the time and date when the revision was made.

The controller 110 then evaluates whether or not the user has instructed movement of a preview image (step S210). The movement instruction can be issued, for example, by the user's drag-and-drop action or flick action performed on the surface of the display section 140, for example, in the direction indicated by the arrow S1 shown in FIG. 6A. The direction indicated by the arrow S1 preferably differs from the first and second directions. The first and second directions are each the direction in which another movement instruction, for example, an instruction of movement of the thumbnail bundle 50a or movement of thumbnail images 51 is issued. In the present example, the direction indicated by the arrow S1 is set along an oblique direction that intersects the first direction.

In a case where an instruction of movement of a preview image has been issued (Yes in step S210), for example, one flick action has been performed, the controller 110 moves the first preview image 30a downward to change the display image in such a way that the second preview image 30b is displayed in the frontmost plane in the form of a full view (step S211), as shown in FIG. 6B. In a case where two flick actions, for example, have been performed in step S211, the controller 110 can move the first preview image 30a and the second preview image 30b downward to change the display image in such a way that the third preview image 30c is displayed in the frontmost plane in the form of a full view.

Although not shown in FIG. 7, when no instruction of movement of a preview image has been issued (No in step S210), the controller 110 keeps displaying the display image in step S204. The controller 110 can stop displaying the display image in step S204 after a set predetermined period elapses or when the user issues a display end instruction.

The series of processes in Display Method 2 for displaying Display Example 2 on the display section 140 and moving a displayed preview image end after the processes are carried out in accordance with the procedure described above.

According to Display Method 2 described above, in which a preview image is moved in response to the instruction of movement of the preview image, such as a flick action performed on the display section 140, and the first preview image 30a displayed as the main-display image is switched, for example, to the second preview image 30b, the user can select a preview image at which the user particularly desires to look and visually recognize the selected preview image as appropriate.

In the state in which the display image has been so changed that the first preview image 30a is moved downward and the second preview image 30b is displayed in the frontmost plane in the form of a full view, as shown in FIG. 6B, the first preview image 30a can be so moved to its original position as to be displayed in front of the second preview image 30b and overlap therewith by performing a drag-and-drop action, a flick action, or any other action on the surface of the display section 140, for example, in the direction opposite the direction indicated by the arrow S1 shown in FIG. 6A.

### 2.3. Display Example 2 Using Preview Images

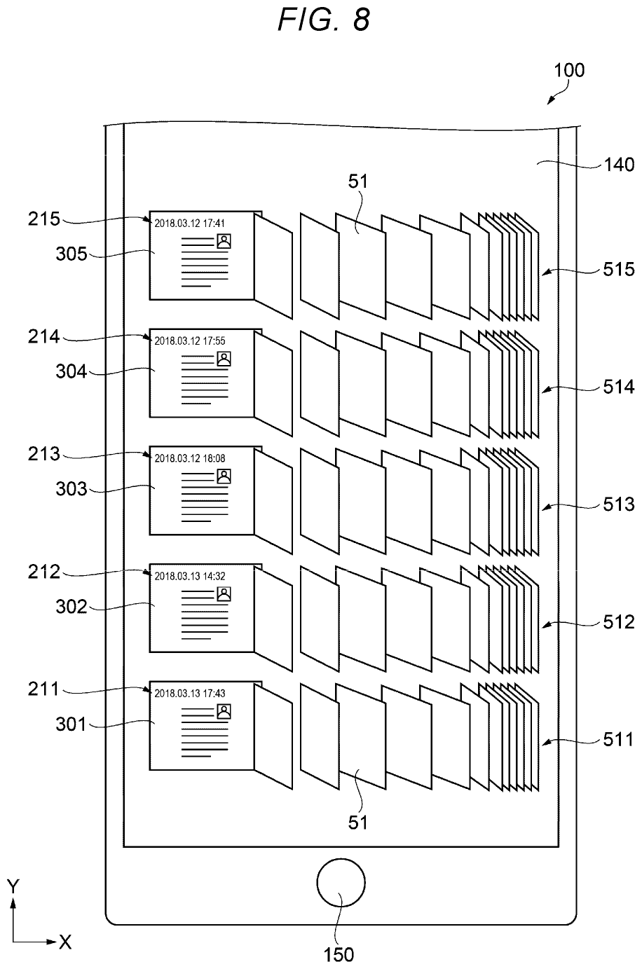

Display Example 2 of a display image using preview images will next be described with reference to FIG. 8. FIG. 8 shows Display Example 2 of a display image using preview images. In Display Example 1 described with reference to FIG. 3, when a file image has revisions, preview images on a revision basis are, for example, juxtaposed and displayed in the first direction, which is the horizontal direction of the display section 140. In contrast to Display Example 1 described above, in Display Example 2, which is the present example, when a file image has revision, thumbnail bundles and preview images are generated on a revision basis, and the thumbnail bundles and the preview images are combined with each other into file images, which are juxtaposed and displayed along the second direction (axis-Y direction), which intersects the first direction.

In Display Example 2 of a display image using preview images, five file images each having a revision image, are displayed, as shown in FIG. 8. The five file images, which are each a file image having a revision, contain a first file image containing a thumbnail bundle 511, in which the plurality of thumbnail images 51 are arranged in the first direction, and a preview image 301 disposed on the left of the thumbnail bundle 511; a second file image containing a thumbnail bundle 512 configured in the same manner as the thumbnail bundle 511 and a preview image 302; a third file image containing a thumbnail bundle 513 configured in the same manner as the thumbnail bundle 511 and a preview image 303; a fourth file image containing a thumbnail bundle 514 configured in the same manner as the thumbnail bundle 511 and a preview image 304; a fifth file image containing a thumbnail bundle 515 configured in the same manner as the thumbnail bundle 511 and a preview image 305. The five file images are sequentially juxtaposed and displayed from the first file image to the fifth file image along the second direction (axis Y), which intersects the first direction. The preview images 301, 302, 303, 304, and 305 are provided with identification marks 211, 212, 213, 214, and 215, which each identify a revision of the file image and show the time and date when the revision was made.

Display Example 2, in which the thumbnail bundles 511, 512, 513, 514, and 515 and the preview images 301, 302, 303, 304, and 305 generated on a revision basis are juxtaposed and displayed as file images in the second direction, allows the user to read and understand the contents of the file images on a revision basis in more detail.

### 2.4. Display Method 3

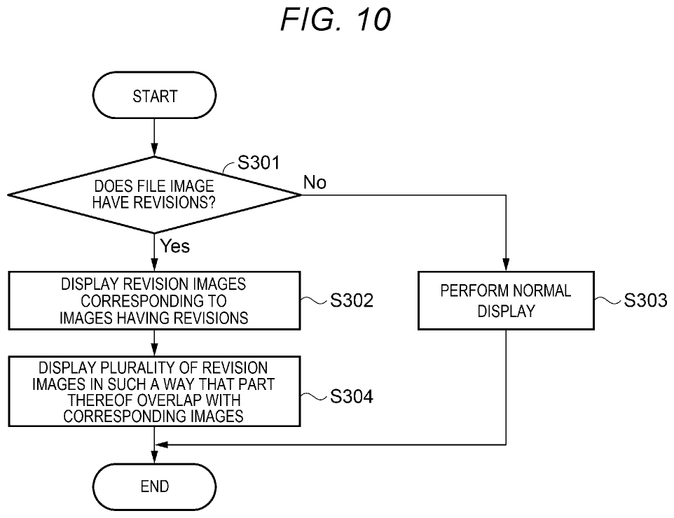

Display Method 3, to which Display Example 3 is applied in the display apparatus 100, will next be described with reference to FIGS. 9 and 10. FIG. 9 shows Display Example 3 of a display image using revision images. FIG. 10 is a flowchart for describing Display Method 3 using revision images. The description will be made with the constituent portions of the display apparatus 100 labeled with the same reference characters described above.

Before the procedure of Display Method 3 shown in FIG. 10, the controller 110 first instructs the thumbnail image generator 120 to generate thumbnail images 52a, 53a, 54a, 55a, and so on as images in a selected file, as shown in FIG. 9. The controller 110 then instructs the display image generator 130 to generate a thumbnail bundle 60a as an image bundle in which the plurality of generated thumbnail images 52a, 53a, 54a, 55a, and so on are arranged in the first direction, and displays the thumbnail bundle 60a on the display section 140. At this point, the controller 110 may display selected thumbnail images, for example, thumbnail images 52a, 53a, and 54a at increased intervals or in the form of images facing each other. The thumbnail images 52a, 53a, 54a, and 55a are generated in the same manner as in Display Method 1 and will therefore not be described in detail.

The controller 110 then evaluates whether or not the displayed file image has revisions (step 301), as shown in the flowchart of FIG. 10. In a case where the file image has revisions (Yes in step S301), the controller 110 instructs the display image generator 130 to generate revision images 52b, 53b, and 54b in the second row and revision images 52c, 53c, and 54c in the third row as a plurality of revision images corresponding to thumbnail images having revisions out of the thumbnail images 52a, 53a, 54a, and 55a, which form the thumbnail bundle 60a, for example, the thumbnail images 52a, 53a, and 54a (step S302).

In a case where the file image has no revision (No in step S301), the controller 110 normally displays the thumbnail bundle 60a, in which the thumbnail images 52a, 53a, 54a, 55a, and so on are juxtaposed (step S303).

The controller 110 then instructs the display image generator 130 to dispose and display the revision images 52b, 53b, and 54b in the second row and the revision images 52c, 53c, and 54c in the third row generated on a revision basis in such a way that the revision images partially overlap with the thumbnail images 52a, 53a, and 54a, respectively (step S304). Specifically, the revision images 52b and 52c are so disposed that part thereof overlaps with the thumbnail image 52a, the revision images 53b and 53c are so disposed that part thereof overlaps with the thumbnail image 53a, and the revision images 54b and 54c are so disposed that part thereof overlaps with the thumbnail image 54a, and the entire images are displayed on the display section 140.

The controller 110 may display identification marks 22b and 22c, which identify the revisions of the revision images 52b and 52c, respectively, which have revisions, in the revision images 52b and 52c. The identification marks 22b and 22c are preferably provided in areas where they do not overlap with each other but are fully exposed when the thumbnail image 52a, the revision image 52b, and the revision image 52c overlap with each other. The identification marks 22b and 22c in the present example each show the time and date when the revision was made. As described above, displaying the identification marks 22b and 22c, which each identify the revision of the corresponding revision image, as supplementary information in the revision images 52b and 52c allows the user to readily grasp the content of the revision and the time and date when the revision was made. In a case where the thumbnail image 52a has a revision, the thumbnail image 52a may be provided with an identification mark that identifies the revision.

The series of processes in Display Method 3 for displaying Display Example 3 on the display section 140 end after the processes are carried out in accordance with the procedure described above.

According to Display Example 3 described above, the revision images 52b, 53b, and 54b in the second row and the revision images 52c, 53c, and 54c in the third row, which correspond to the thumbnail images 52a, 53a, and 54a having revisions out of the thumbnail images 52a, 53a, 54a, and 55a, which form the thumbnail bundle 60a as an image bundle, are generated on a revision basis, and the plurality of generated revision images 52b, 53b, 54b, 52c, 53c, and 54c are so displayed that part thereof overlaps with the corresponding thumbnail images 52a, 53a, and 54a. The user can therefore readily visually recognize the plurality of revision images 52b, 53b, 54b, 52c, 53c, and 54c generated on a revision basis as a display image in the form of a list.

### 2.5. Display Method 4

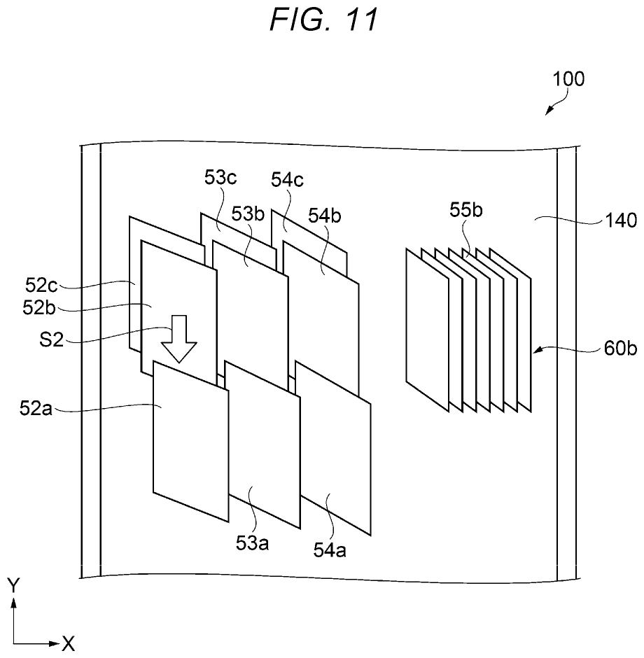

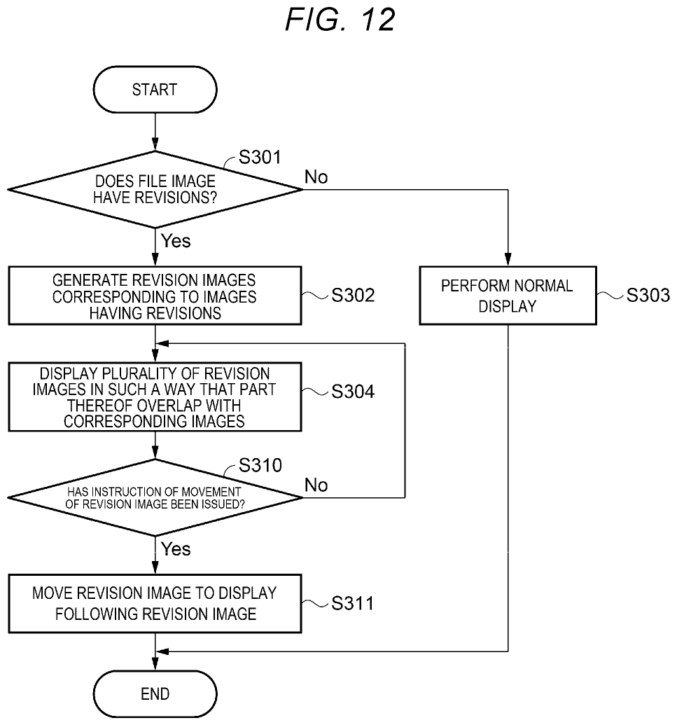

Display Method 4 used with the display apparatus 100 will next be described with reference to FIGS. 11 and 12. FIG. 11 describes movement of a revision image. FIG. 12 is a flowchart for describing Display Method 4 using revision images. Display Method 4 uses a display configuration having a thumbnail bundle 60b containing revision images on a revision basis, which is the same configuration as that described in above-mentioned Display Method 3. The same configurations as those in Display Method 3 therefore have the same reference characters. The description of Display Method 4 will also be made with the constituent portions of the display apparatus 100 labeled with the same reference characters described above.

As shown in FIG. 11, before the procedure of Display Method 4 shown in FIG. 12, the controller 110 first instructs the thumbnail image generator 120 to generate thumbnail images 52a, 53a, 54a, 55b, and so on as images in a selected file, instructs the display image generator 130 to generate a thumbnail bundle 60b as an image bundle in which the plurality of generated thumbnail images 52a, 53a, 54a, 55b, and so on are arranged in the first direction, and displays the thumbnail bundle 60b on the display section 140. At this point, the controller 110 may display selected thumbnail images, for example, thumbnail images 52a, 53a, and 54a at increased intervals or in the form of images facing each other. The thumbnail images 52a, 53a, 54a, and 55b are generated in the same manner as in Display Method 1 and will therefore not be described in detail.

The controller 110 then evaluates whether or not the displayed file image has revisions (step 301), as shown in the flowchart of FIG. 12. In a case where the file image has revisions (Yes in step S301), the controller 110 instructs the display image generator 130 to generate the revision images 52b, 53b, and 54b in the second row and the revision images 52c, 53c, and 54c in the third row as a plurality of revision images corresponding to thumbnail images having revisions out of the thumbnail images 52a, 53a, 54a, and 55b, which form the thumbnail bundle 60b, for example, the thumbnail images 52a, 53a, and 54a (step S302).

In a case where the file image has no revision (No in step S301), the controller 110 normally displays the thumbnail bundle 60b, in which the thumbnail images 52a, 53a, 54a, 55b, and so on are juxtaposed (step S303).

The controller 110 then instructs the display image generator 130 to dispose and display the revision images 52b, 53b, and 54b in the second row and the revision images 52c, 53c, and 54c in the third row generated on a revision basis in such a way that the revision images partially overlap with the thumbnail images 52a, 53a, and 54a, respectively (step S304). Specifically, the revision images 52b and 52c are so disposed that part thereof overlaps with the thumbnail image 52a, the revision images 53b and 53c are so disposed that part thereof overlaps with the thumbnail image 53a, and the revision images 54b and 54c are so disposed that part thereof overlaps with the thumbnail image 54a, and the entire images are displayed on the display section 140.

The controller 110 then evaluates whether or not the user has instructed movement of a revision image (step S310). The movement instruction can be issued, for example, by a drag-and-drop action, a flick action, or any other action performed on the surface of the display section 140, for example, in the direction indicated by the arrow S2 shown in FIG. 11. The direction indicated by the arrow S2 can be a set direction, for example, the second direction.

In a case where an instruction of movement of a revision image has been issued (Yes in step S310), for example, one flick action has been performed, the controller 110 moves the thumbnail images 52a, 53a, and 54a in the first row downward to change the display image in such a way that the revision images 52b, 53b, and 54b in the second row are each displayed in the frontmost plane in the form of a full view (step S311), as shown in FIG. 11. In a case where two flick actions, for example, have been performed in step S311, the controller 110 can move the revision images 52b, 53b, and 54b in the second row downward to change the display image in such a way that the revision images 52c, 53c, and 54c in the third row are each displayed in the frontmost plane in the form of a full view.

Although not shown in FIG. 11, when no instruction of movement of a revision image has been issued (No in step S310), the controller 110 keeps displaying the display image in step S304. The controller 110 can stop displaying the display image in step S304 after a set predetermined period elapses or when the user issues a display end instruction.

The series of processes in Display Method 4 for displaying Display Example 3 on the display section 140 and moving a displayed revision image end after the processes are carried out in accordance with the procedure described above.

According to Display Method 4 described above, in addition to the same effects provided by Display Method 3 described above, the revision image movement instruction issued, for example, by a flick action performed on the display section 140 moves the thumbnail images 52a, 53a, and 54a, the revision images 52b, 53b, and 54b in the second row, or the revision images 52c, 53c, and 54c in the third row. The movement switches, for example, the thumbnail images 52a, 53a, and 54a each displayed as the main-display image to the revision images 52b, 53b, and 54b, whereby the user can select a revision image at which the user particularly desires to look and visually recognize the selected revision image as appropriate.

Display Method 4 has been described on the assumption that the images each displayed as the main-display image before the movement are the thumbnail images 52a, 53a, and 54a. In a case where the thumbnail images 52a, 53a, and 54a each also have revisions, the thumbnail images 52a, 53a, and 54a can each be rephrased to a revision image.

In the state in which the display image has been so changed that the thumbnail images 52a, 53a, and 54a are moved downward and the revision images 52b, 53b, and 54b in the second row are each displayed in the frontmost plane in the form of a full view, as shown in FIG. 11, the thumbnail images 52a, 53a, and 54a can be so moved to their original positions as to be displayed in front of the revision images 52b, 53b, and 54b in the second row and overlap therewith by performing a drag-and-drop action, a flick action, or any other action on the surface of the display section 140 in the direction opposite the direction indicated by the arrow S2.

### 2.6. Display Example 4 Using Revision Images

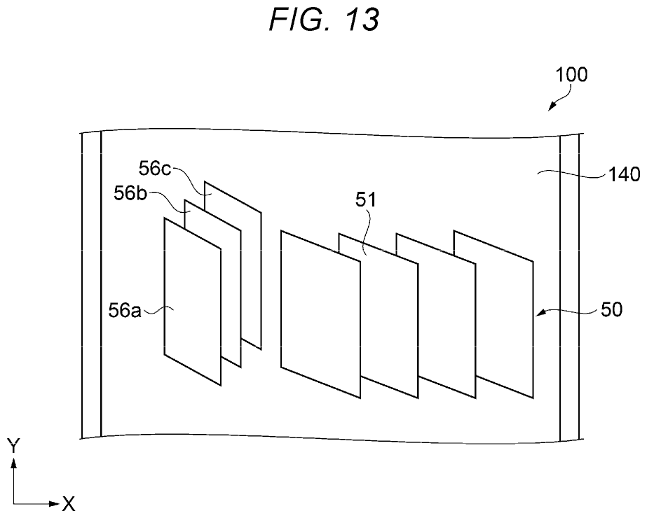

Display Example 4 of a display image using revision images will next be described with reference to FIG. 13. FIG. 13 shows Display Example 4 of a display image using revision images.

In Display Example 3 described with reference to FIG. 11, when a file image has revisions, the revision images 52b, 53b, and 54b or other revision images corresponding to the thumbnail images 52a, 53a, and 54a as images each having revisions are generated, and the revision images 52b, 53b, and 54b are so juxtaposed and displayed behind the thumbnail images 52a, 53a, and 54a that part of the revision images 52b, 53b, and 54b overlaps with the thumbnail images 52a, 53a, and 54a. As compared with Display Example 3 described above, in Display Example 4, which is the present example, when a file image has revisions, revision images corresponding to a representative thumbnail image are generated on a revision basis, and the generated revision images are so juxtaposed and displayed behind the representative thumbnail image that part of the revision images overlaps with the representative thumbnail image. In a case where the representative thumbnail image also has revisions, the representative thumbnail image can be rephrased to a revision image.

In Display Example 4, in which a display image uses revision images, the display image is assumed to contain three file images each having revisions, as shown in FIG. 13. In Display Example 4, the thumbnail bundle 50, in which the plurality of thumbnail images 51 are juxtaposed in the first direction, is displayed, and a left-end thumbnail image 56a is selected as the representative thumbnail image. In the following description, the selected thumbnail images 56a is rephrased to a revision image 56a.

Revision images 56a, 56b, and 56c are then generated as revision images in the three file images each having revisions, with the revision image 56b so displayed behind the revision image 56a that part of the revision image 56b overlaps with the revision image 56a, and the revision image 56c so displayed behind the revision image 56b that part of the revision image 56c overlaps with the revision image 56b. That is, the three revision images 56a, 56b, and 56c are so juxtaposed and disposed obliquely rearward that part of the revision images 56a, 56b, and 56c overlaps with each other, and the thus disposed revision images 56a, 56b, and 56c are displayed on the display section 140. Although not shown, identification marks that identify the revisions of the three revision images 56a, 56b, and 56c may be displayed as supplementary information in the revision images 56a, 56b, and 56c.

According to Display Example 4 described above, when a file image has revisions, the revision images 56b and 56c corresponding to the representative thumbnail image 56a, in other words, the revision image 56a are generated on a revision basis and so displayed behind the representative thumbnail image 56a that part of the revision images 56b and 56c overlaps with the representative thumbnail image 56a. The user can therefore readily visually recognize the plurality of revision images 56a, 56b, and 56c on a revision basis as a display image involving revisions in the form of a list. 2.7. Display Example 5 using revision images

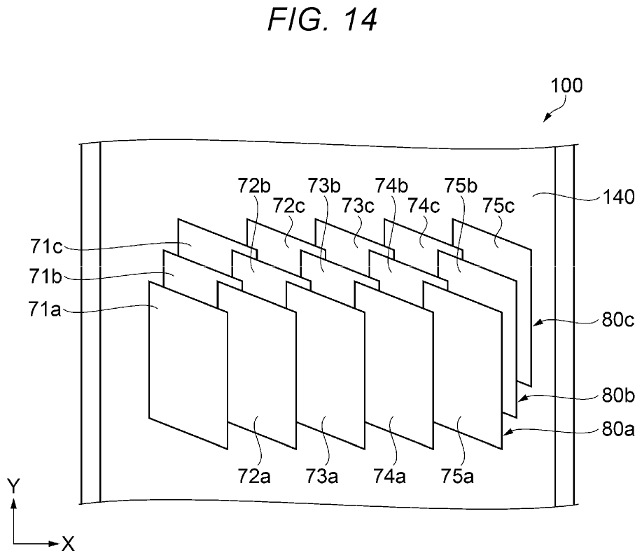

Display Example 5 of a display image using revision images will next be described with reference to FIG. 14. FIG. 14 shows Display Example 5 of a display image using revision images.

In Display Example 4 described with reference to FIG. 13, when a file image has revisions, the revision images 56b and 56c corresponding to the representative thumbnail image 56a are generated on a revision basis, and the revision images 56b and 56c are so juxtaposed and displayed behind the representative thumbnail image 56a that part of the revision images 56b and 56c overlaps with the representative thumbnail image 56a. As compared with Display Example 4 described above, in Display Example 5, when a file image has revisions, second revision images corresponding to all thumbnail images are generated on a revision basis, and the second revision images are so displayed behind the thumbnail images that part of the second revision images overlaps with all the thumbnail images or the second thumbnail images themselves.

In Display Example 5, in which a display image uses revision images, the display image is assumed to contain three file images each having revisions, as shown in FIG. 14. In Display Example 5, for example, a thumbnail bundle 80a, in which a plurality of thumbnail images 71a, 72a, 73a, 74a, and 75a are juxtaposed in the first direction, is displayed as a main-display image bundle. In a case where the thumbnail bundle 80a has revisions, the thumbnail images 71a, 72a, 73a, 74a, and 75a, which form the thumbnail bundle 80a, can be rephrased to revision images.

Specifically, in Display Example 5, the thumbnail bundle 80a, which is formed of the plurality of thumbnail images 71a, 72a, 73a, 74a, and 75a as revision images of a first file image having revisions, is displayed. In the present example, the thumbnail image 71a is presented as an image having revisions by way of example in the following description.

In addition, as revision images of a second file image having revisions, a revision image 71b and second revision images 72b, 73b, 74b, and 75b corresponding to the plurality of thumbnail images 71a, 72a, 73a, 74a, and 75a, respectively, which form the thumbnail bundle 80a, are generated. The revision image 71b and the second revision images 72b, 73b, 74b, and 75b corresponding to the thumbnail images 71a, 72a, 73a, 74a, and 75a are then so displayed obliquely behind the thumbnail images 71a, 72a, 73a, 74a, and 75a that part of the revision image 71b and the second revision images 72b, 73b, 74b, and 75b overlaps with the thumbnail images 71a, 72a, 73a, 74a, and 75a, respectively. The image bundle formed of the revision image 71b and the second revision images 72b, 73b, 74b, and 75b forms an apparent thumbnail bundle 80b.

Further, as revision images of a third file image having revisions, a revision image 71c and second revision images 72c, 73c, 74c, and 75c corresponding to the plurality of thumbnail images 71a, 72a, 73a, 74a, and 75a, respectively, which form the thumbnail bundle 80a, are generated. The revision image 71c and the second revision images 72c, 73c, 74c, and 75c corresponding to the revision image 71b and the second revision images 72b, 73b, 74b, and 75b are so displayed obliquely behind the revision image 71b and the second revision images 72b, 73b, 74b, and 75b that part of the revision image 71c and the second revision images 72c, 73c, 74c, and 75c overlaps with the revision image 71b and the second revision images 72b, 73b, 74b, and 75b, respectively. The image bundle formed of the revision image 71c and the second revision images 72c, 73c, 74c, and 75c forms an apparent thumbnail bundle 80c.

Although not shown, identification marks that identify the revisions of the file images may be displayed as supplementary information in at least one of the thumbnail images 71a, 72a, 73a, 74a, and 75a, at least one of the revision image 71b and the second revision images 72b, 73b, 74b, and 75b, and at least one of the revision image 71c and the second revision images 72c, 73c, 74c, and 75c.

According to Display Example 5 described above, when a file image has revisions, the revision image 71b and the second revision images 72b, 73b, 74b, and 75b and the revision image 71c and the second revision images 72c, 73c, 74c, and 75c corresponding to the thumbnail images 71a, 72a, 73a, 74a, and 75a, respectively, are generated on a revision basis. The generated revision images corresponding to the thumbnail images are then so disposed that part of the revision images overlaps with the thumbnail images, respectively, and the entire images are displayed on the display section 140. The user can therefore readily visually recognize the thumbnail bundles 80a, 80b, and 80c, which are a plurality of image bundles formed of images on a revision basis, as a display image involving revisions in the form of a list.

The above embodiment has been described with reference to a smartphone-type communication terminal apparatus as the display apparatus 100, but not necessarily. Examples of other display apparatuses may include a tablet terminal, a display of a personal computer, and the like. Further, the display apparatus can, for example, be a projector that uses a screen for video projection as the display section and projects an image containing an image bundle, such as a thumbnail bundle containing thumbnail images or other images, and other images on the screen.

Contents derived from the embodiment described above are described below as aspects of the present disclosure.

Aspect 1: A display method according to the present aspect is a display method for displaying a file image on a display section, the file image containing images to be so displayed as to be disposed along a first imaginary axis, rotated around second imaginary axes that intersect the first imaginary axis, and further rotated around the first imaginary axis. In a case where the file image has revisions, preview images corresponding to the file image are generated for each of the revisions, and the plurality of generated preview images are so displayed as to partially overlap with each other.

In the display method according to the present aspect, preview images corresponding to the file image are generated on a revision basis, and the plurality of generated preview images are so displayed as to partially overlap with each other. The user can therefore readily visually recognize the plurality of preview images on a revision basis as a display image in the form of a list. The user can therefore visually recognize the plurality of preview images generated in relation to the revisions of the file image in the form of a list of the nonoverlapping portions of the preview images, whereby the user can readily recognize the contents of the progress of the revisions and transition thereof.

Aspect 2: In the display method described in the above aspect, the preview images may be generated in correspondence with an image selected from the plurality of images.

According to the present aspect, in which the preview images correspond to an image selected from the plurality of images that form the file image, the user can readily grasp the content of the file image by visually recognizing the preview images.

Aspect 3: In the display method described in the above aspect, the file image may include an image bundle in which the plurality of images are juxtaposed in a first direction and the preview images juxtaposed with the image bundle.

According to the present aspect, in which the file image is displayed in a display form in which the preview images are juxtaposed with the image bundle in which the plurality of images are juxtaposed, the user can readily read and understand the content contained in the file image.

Aspect 4: In the display method described in the above aspect, the image bundle and the preview images may be generated for each of the revisions, and the image bundles and the preview images may be juxtaposed and displayed along a second direction that intersects the first direction.

According to the present aspect, in which the image bundles and the preview images generated on a revision basis are juxtaposed and displayed in the second direction, the user can read and understand the content of the file image on a revision basis in more detail.

Aspect 5: In the display method described in the above aspect, identification marks that identify the revisions of the preview images may be displayed in the preview images.

According to the present aspect, in which the identification marks that identify the revisions of the preview images are displayed as supplementary information in the preview images, the user can readily grasp the contents of the revisions of the preview images.

Aspect 6: In the display method described in the above aspect, when an instruction of movement of one of the preview images so displayed as to overlap with each other on a revision basis is issued, the instructed preview image is so moved that the preview image displayed as a main-display image is switched to another.

According to the present aspect, in response to the instruction of movement of the preview image, the preview image is moved and the preview image displayed as the main-display image is switched, the user can select a preview image at which the user particularly desires to look and visually recognize the selected preview image as appropriate.

Aspect 7: A display method according to the present aspect is a display method for displaying a file image on a display section, the file image containing images to be so displayed as to be disposed along a first imaginary axis, rotated around second imaginary axes that intersect the first imaginary axis, and further rotated around the first imaginary axis. The file image contains an image bundle in which the plurality of images are juxtaposed in a first direction. In a case where the file image has revisions, a plurality of revision images corresponding to an image having the revisions out of the images that form the image bundle are generated, and the revision images are so displayed as to partially overlap with each other.

According to the present aspect, revision images corresponding to an image having revisions out of the images that form the image bundle are generated on a revision basis, and the plurality of generated revision images are so displayed as to partially overlap with each other. The user can therefore readily visually recognize the plurality of revision images on a revision basis as a display image in the form of a list. The user can therefore visually recognize the plurality of revision images generated in relation to the revisions of the file image in the form of a list of the nonoverlapping portions of the revision images, whereby the user can readily recognize the contents of the progress of the revisions and transition thereof.

Aspect 8: In the display method described in the above aspect, in addition to the image having the revisions, second revision images corresponding to all the images that form the image bundle may be generated on a revision basis, and the second revision images generated on a revision basis may be so displayed as to partially overlap with each other.

According to the present aspect, an image having revisions out of the images that form the image bundle and second revision images corresponding to all the images that form the image bundle containing the image having revisions are generated on a revision basis, and the generated second revision images are so displayed that part of the second revision images overlaps with each other. The user can therefore readily visually recognize a display image in the form of a list containing the revision images and the second revision images on a revision basis in all the images that form the image bundle.

Aspect 9: In the display method described in the above aspect, when an instruction of movement of one of the revision images so displayed as to overlap with each other on a revision basis is issued, the instructed revision image may be so moved that the revision image displayed as a main-display image is switched to another.

According to the present aspect, in response to the instruction of movement of the preview image, the preview image is moved and the preview image displayed as the main-display image is switched, the user can select a revision image at which the user particularly desires to look and visually recognize the selected revision image as appropriate.

Aspect 10: A display apparatus according to the present aspect includes a display section that displays a file image containing images, a thumbnail image generator that generates a plurality of the images to be so displayed as to be disposed along a first imaginary axis, rotated around a second imaginary axis that intersect the first imaginary axis, and further rotated around the first imaginary axis, and a display image generator that generates, when the file image has revisions, a preview image selected from the plurality of images on a revision basis and generates a display image in which the plurality of preview images are displayed with part thereof overlapping with each other.

In the display apparatus according to the present aspect, the display image generator generates preview images corresponding to a file image containing the images generated by the thumbnail image generator on a revision basis and displays the plurality of generated preview images on the display section with part of the preview images overlapping with each other. A display apparatus that allows the user to readily visually recognize the plurality of preview images on a revision basis as a display image in the form of a list can be provided.

Aspect 11: A display apparatus according to the present aspect includes a display section that displays a file image containing images, a thumbnail image generator that generates a plurality of the images to be so displayed as to be disposed along a first imaginary axis, rotated around a second imaginary axis that intersect the first imaginary axis, and further rotated around the first imaginary axis, and a display image generator that generates, when the file image has revisions, a plurality of revision images corresponding to an image having the revisions out of the plurality of images and generates a display image in which the plurality of revision images are displayed with part thereof overlapping with each other.

In the display apparatus according to the present aspect, the display image generator generates a plurality of revision images corresponding to an image having revisions in the file image containing the images generated by the thumbnail image generator and displays the plurality of generated revision images on the display section with part of the revision images overlapping with each other. A display apparatus that allows the user to readily visually recognize the plurality of images so displayed as to overlap with each other on a revision basis as a display image in the form of a list can be provided.

What is claimed is:

1. A display method for displaying a file image on a display section, the file image containing images to be so displayed as to be disposed along a first imaginary axis, rotated around second imaginary axes that intersect the first imaginary axis, and further rotated around the first imaginary axis, the method comprising:
generating, when the file image has revisions, preview images corresponding to the file image for each of the revisions; and
displaying the plurality of generated preview images in such a way that the plurality of generated preview images partially overlap with each other.

2. The display method according to claim 1,
wherein the preview images are generated in correspondence with an image selected from the plurality of images.

3. The display method according to claim 1,
wherein the file image includes
an image bundle in which the plurality of images are juxtaposed in a first direction, and
the preview images juxtaposed with the image bundle.

4. The display method according to claim 3,
wherein the image bundle and the preview images are generated for each of the revisions, and
the image bundles and the preview images are juxtaposed and displayed along a second direction that intersects the first direction.

5. The display method according to claim 1,
wherein identification marks that identify the revisions of the preview images are displayed in the preview images.

6. The display method according to claim 1,
wherein when an instruction of movement of one of the preview images so displayed as to overlap with each other on a revision basis is issued, the instructed preview image is so moved that the preview image displayed as a main-display image is switched to another.

7. A display method for displaying a file image on a display section, the file image containing images to be so displayed as to be disposed along a first imaginary axis, rotated around second imaginary axes that intersect the first imaginary axis, and further rotated around the first imaginary axis,
wherein the file image contains an image bundle in which the plurality of images are juxtaposed in a first direction, and
when the file image has revisions, a plurality of revision images corresponding to an image having the revisions out of the images that form the image bundle are generated, and the revision images are so displayed as to partially overlap with each other.

8. The display method according to claim 7,
wherein in addition to the image having the revisions, second revision images corresponding to all the images that form the image bundle are generated on a revision basis, and
the second revision images generated on a revision basis are so displayed as to partially overlap with each other.

9. The display method according to claim 7,
wherein when an instruction of movement of one of the revision images so displayed as to overlap with each other on a revision basis is issued, the instructed revision image is so moved that the revision image displayed as a main-display image is switched to another.

10. A display apparatus comprising:
a display section that displays a file image containing images;
a thumbnail image generator that generates a plurality of the images to be so displayed as to be disposed along a first imaginary axis, rotated around a second imaginary axis that intersect the first imaginary axis, and further rotated around the first imaginary axis; and
a display image generator that generates, when the file image has revisions, a preview image selected from the plurality of images on a revision basis and generates a display image in which the plurality of preview images are displayed with part thereof overlapping with each other.

11. A display apparatus comprising:
a display section that displays a file image containing images;
a thumbnail image generator that generates a plurality of the images to be so displayed as to be disposed along a first imaginary axis, rotated around a second imaginary axis that intersect the first imaginary axis, and further rotated around the first imaginary axis; and
a display image generator that generates, when the file image has revisions, a plurality of revision images corresponding to an image having the revisions out of the plurality of images and generates a display image in which the plurality of revision images are displayed with part thereof overlapping with each other.
